(19) United States
(12) Patent Application Publication
(10) Pub. No.: US 2022/0349708 A1
(43) Pub. Date: Nov. 3, 2022

(54) GENERATING ERROR DATA

(71) Applicant: Hewlett-Packard Development Company, L.P., Spring, TX (US)

(72) Inventors: Fraser John Dickin, Bristol (GB); Stephen Bernard Pollard, Bristol (GB); Guy De Warrenne Bruce Adams, Bristol (GB); Faisal Azhar, Bristol (GB)

(73) Assignee: Hewlett-Packard Development Company, L.P., Spring, TX (US)

(21) Appl. No.: 17/774,189

(22) PCT Filed: Nov. 19, 2019
(86) PCT No.: PCT/US2019/062196

§ 371 Date: May 4, 2022

(51) Int. Cl. G01B 11/25

(52) U.S. Cl. CPC G01B 11/2545; G01B 11/2504

(57) ABSTRACT

A system comprising a scanner to scan an object and a controller. The controller can cause an object to be moved to a plurality of locations to be scanned by the scanner. At each location the controller can cause the scanner to scan the object to create scan data and can cause a reference device to create reference data relating to the object. The scan data can be processed to create scan position data indicative of a measured scan position of the object and can cause the reference data to be processed to create reference position data indicative of a measured reference position of the object. The controller can also cause the generation of error data indicative of a position error in the scan data at each of the plurality of locations based on the scan position data and the reference position data.

Scanning an object surface in three dimensions to create digital data, for example to create a digital model of the object, may be helpful when trying to recreate an existing object, or when trying to validate objects created by additive manufacturing processes.

Various scanners exist that can be used to scan objects. The accuracy of such scanners continues to improve, but errors may still be present in the scan data

Examples of the present disclosure will now be described with reference to the accompanying Figures, in which:

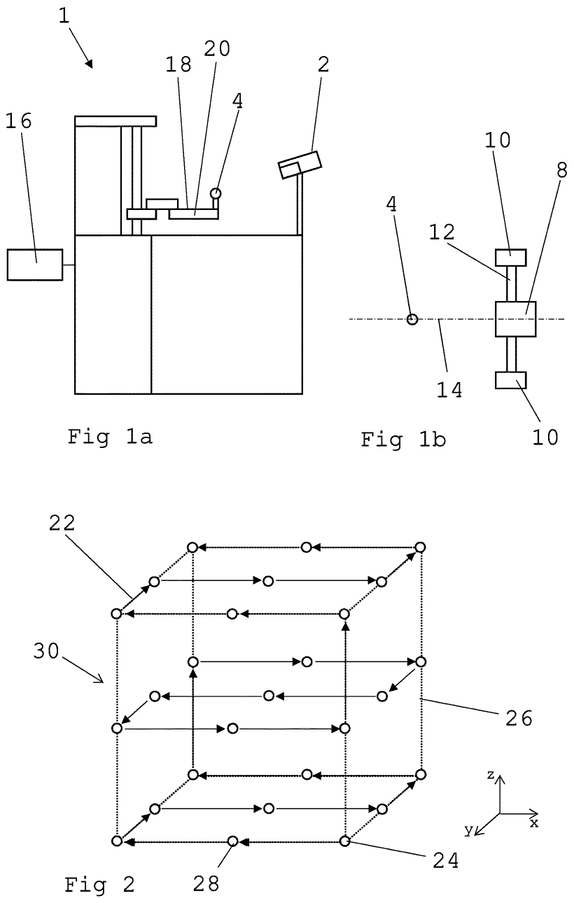

FIG. 1 a shows a schematic view of an example of system comprising a scanner;

FIG. 1b shows a schematic view of an example of a scanner;

FIG. 2 illustrates an example of a path along which an object may be moved;

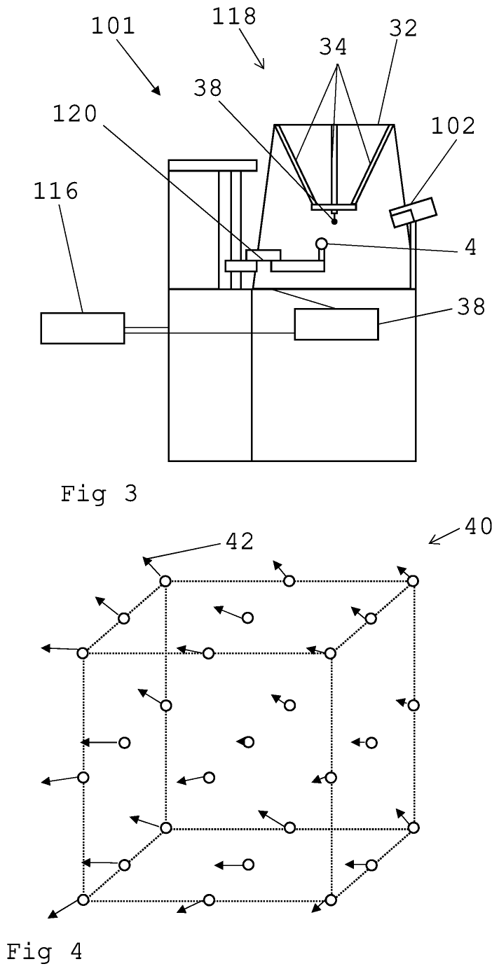

FIG. 3 shows a schematic view of a different example of a system comprising a scanner;

FIG. 4 is an example of a representation of the positional errors identified in scan data;

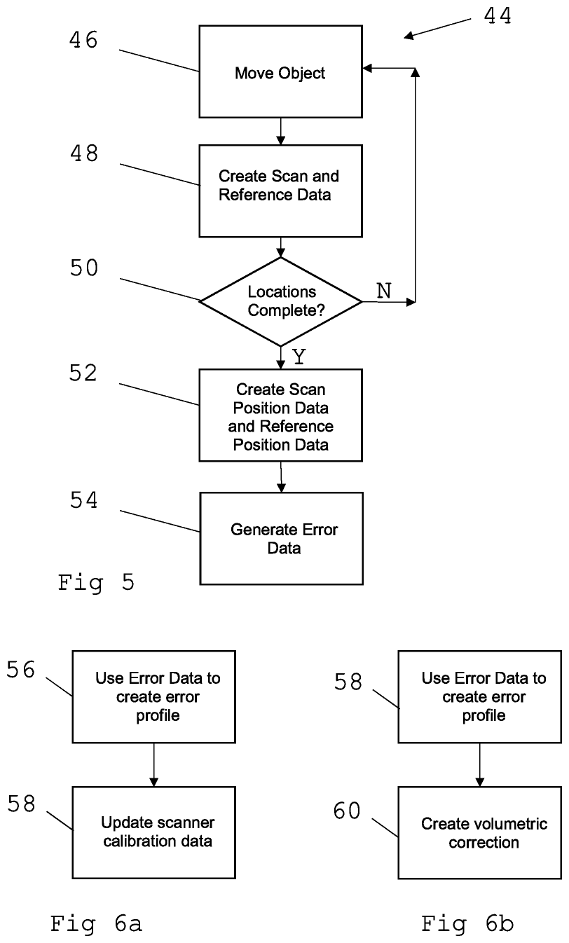

FIG. 5 shows a flow chart of an example of a method;

FIGS. 6a and 6b show flow charts of parts of further example methods; and

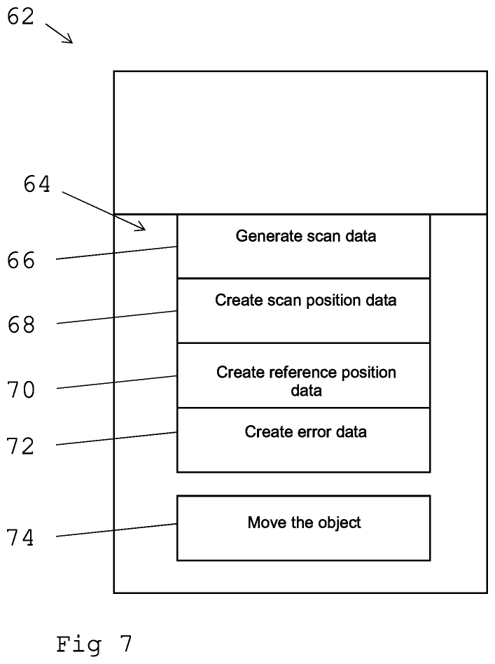

FIG. 7 shows a schematic representation of an example of a controller.

FIG. 1a shows a system 1 comprising a scanner 2 to scan an object 4. The scanner 2 can be any suitable scanning device that is able to scan an object 4 to create scan data which can be processed to create position data which is indicative of the position of the object 4 relative to the scanner. The scanner 2 may be a non-contact scanner, such as an optical, laser or ultrasonic scanner. In this example the scanner 2 is a 3-D structured light scanner 6 and is shown in more detail in FIG. 1b.

FIG. 1b shows an example of a structured light scanner 6, although other forms of scanner could be used. The structured light scanner comprises a projector 8 and sensors 10. In a simplified example, during use of the structured light scanner 6 the projector 8 projects a pattern of light onto an object 4 to produce an illumination pattern on the object 4. The illumination pattern appears distorted from perspectives other than that of the projector 8. In other examples the projector 8 may project a single line of light, lines of light, a plurality of patterns, or may project any suitable pattern of light, linear or non-linear and in any suitable colour.

The structured light scanner 6 includes two sensors 10, in this example the sensors 10 are digital cameras, positioned on a mount 12 at a known position and orientation relative to the projector 8. The sensors 10 are arranged away from a central axis 14 of the projector so that each sensor 10 can view the object 4 from a perspective other than that of the projector 8. It should be noted that, in other examples, only one sensor may be included, or more than two sensors 10 may be included.

The sensors 10 are used to detect the illumination pattern on the object 4 projected by the projector 8. By analysing the distortion of the pattern from a perspective other than that of the projector 8 it is possible to determine, for example via triangulation, information about the position and shape of the object 4 which is illuminated by the projector 8. This information can be determined by processing the scan data to create scan position data.

A simplified example of a structured light scanner is described above, but there are a variety of other examples. Structured light scanners may use multiple sensed images of the illuminated object to determine scan position data. There are also scanners which use single sensed images of the illuminated object to determine the scan position data. To generate high resolution three dimensional images of an object a plurality of patterns may be used and/or grey scales and/or a plurality of colours may be used. In some scanners a plurality of phase shifted sine wave patterns are projected onto an object and the resulting distorted illumination patterns analysed to determine the scan position data. These are only some examples of structured light scanners and techniques. The system 1 may include any suitable structured light scanner and the scanner could make use of any suitable technique, or a combination of techniques.

Referring again to FIG. 1a, the system 1 further comprises a controller 16. At each of a plurality of locations, the controller 16 is also able to cause the scanner 2 to scan the object 4 to create scan data and the controller 16 causes a reference device 18 to create reference data relating to the object 4. The object 4 may be moved manually to each of the locations, for example using a stand and clamp. The object 4 could be supported by an automatically movable object support, and the controller 16 may be able to cause the object 4 to be moved automatically to a plurality of locations in which it can be scanned by the scanner 2. A combination of manual movement and automatic movement may also be used, for example a height, for example in a z-direction, may be manually adjusted and an automated stage may then move the object in the x- and y-direction. The orientation of the object 4 may be adjusted and/or controlled.

These locations may be limited by a manufacturer defined scan volume for the scanner 2, outside of which the manufacturer does not guarantee that the scanner 2 will work, or does not guarantee the accuracy of the scanner 2. The locations may also be limited by physical constraints, for example for the structured light scanner 6 it is necessary that the projector 8 is able to project the plurality of lines onto the object 4.

In this example the reference device 18 of the system comprises a jointed and vertically movable arm 20 which also acts as an object support and carries the object 4. The vertical position of the arm 20 and the orientation of the joints of the arm 20 can be recorded at each location to create reference data relating to the object 4. In this example the arm 20 is a manually movable arm 20 which is movable by a user so that the object 4 can be positioned in the plurality of locations manually. As discussed above, the movement may be at least partly automatic.

The controller 16 is able to cause the scan data to be processed to create scan position data indicative of a measured scan position of the object 4 at each location. The controller 16 is also able to cause the reference data to be processed to create reference position data indicative of a measured reference position of the object 4 at each location.

The measured scan position of the object 4 at each location is determined from the scan data by processing the scan data to identify the object 4 and determining a position of a particular feature of the object 4. In this example the object 4 is a sphere and the position of the object 4 is determined by determining the position of the centre of the sphere from the scan data. In other examples a different feature may be selected, for example the top of the sphere, or a different object may be used, for example a cube and the feature may be a corner of the cube. In some examples, the feature of the object 4, the position of which is determined, may be an external feature which can be directly sensed by the scanner, for example the corner of a cube, or may be an internal feature the position of which can be calculated based on measurements of external elements of the object, for example the centre of a sphere which can be calculated based upon a determination of the position of points on the exterior of the sphere.

The controller 16 is further able to cause the generation of error data. The error data is indicative of a position error in the scan data at each of the plurality of locations and is based on the scan position data and the reference position data.

To allow for errors in the scan data to be determined with acceptable accuracy the reference device 18 may have a greater inherent accuracy than the scanner 2, or the errors of the reference device 18 may be well characterised so that the reference data and/or reference position data can be processed to reduce errors to a level below the anticipated errors in the scan data and/or scan position data.

The reference device 18 provides a source of information against which the information from the scan data from the scanner 2 can be checked. In this example the reference position data allows errors in the scan position data to be identified. The reference device 18 may be able to provide reference position data that is more accurate than that anticipated from the scanner 2. The reference device 18 may be able to provide reference position data in which errors are 30% of those anticipated from the scanner 2, for example if the scanner error is anticipated at +/−100 μm, the accuracy of the reference device 18 may be +/−30 μm or lower.

The reference device 18 may be able to provide reference position data in which errors are 10% of those anticipated from the scanner 2, for example if the scanner error is anticipated at +/−100 μm, the accuracy of the reference device 18 may be +/−10 μm or lower, this could be referred to as being able to provide reference position data that is an order of magnitude more dimensionally accurate than is anticipated for the scanner 2.

FIG. 2 shows an example of a path 22 along which an object 4 may be moved in the system 1. The object 4 may start in the front left corner 24 of the volume 26 to be characterised. The volume 26 may be any suitable shape within the volume that can be scanned by the scanner, for example a cube, a cuboid, sphere or cylinder. The volume 26 may be regular or irregular. In this example the volume 26 is substantially cubic in shape.

The object 4 is scanned and reference data created at the start location 24 and then moves half way along the bottom front edge of the volume to the second location 28 where the object 4 is again scanned and reference data created. The process of moving the object 4 to each of the plurality of locations 30 and creating scan and reference data in that location 30 continues as the object is moved along the path 22. In this example a 3×3×3 grid of locations 30 is created as this is an efficient way in which to move the object through the volume 22, each movement being a distance that is half the length of a side of the cubic volume 26 either in the x, y, or z direction. This regular spacing is particularly suitable for cubic volumes 24 to be characterised and the use of a grid pattern for the locations may facilitate processing of the data.

In other examples a 4×4×4 grid of locations 30 may be used. Increasing the number of locations in the plurality of locations may increase the accuracy with which the error profile can be characterised and it may also increase the processing complexity for the data.

In other examples an irregular distribution of locations 30 might be used. Locations 30 may be distributed randomly, or may be concentrated in a particular region of the volume 26 that may be of particular interest.

The error data generated by the system 1 can be used for a variety of purposes. It can be used to characterise an error profile of the scanner 2. The error data may comprise a random error component which cannot be predicted and a systemic error component which can be predicted. The error profile of the scanner 2 may characterise the systemic error component of the error data.

Once the error profile of the scanner 2 is characterised, it is possible that a volumetric correction can be generated based on the error data. The volumetric correction may include correction parameters that can be applied to scan data and/or scan position data to produce corrected scan data and/or corrected scan position data in which systemic errors in the scan data are reduced. In this example a volumetric correction transformation matrix may be generated which can be applied to the scan data and/or scan position data once it has been generated to reduce systemic errors from the scanner 2.

In other embodiments the error profile of the scanner 2 can be used to improve the accuracy of the scanner 2 by updating calibration data which is used by the scanner to create and/or process the scan data. The update of the calibration data may reduce systemic volumetric errors in the scan data and/or the scan position data. The controller 16 may be able to automatically update the calibration data of the scanner 2, or may be able to produce calibration data which can be used to update the calibration of the scanner 2.

FIG. 3 shows a schematic view of a different example of a system 101 comprising a scanner 102. Like components will be referenced with the same numerals incremented by 100.

In this example the system 101 comprises a robotic arm 120 to move the object 4 into the plurality of locations. The controller 116 is able to cause the robotic arm 120 to move the object 4 to the plurality of locations automatically without user intervention.

The robotic arm 120 of system 101 could provide a reference device 118 as in the system 1, but in this example a separate reference device 118 in the form of a Co-ordinate Measuring Machine (CMM) 32 is provided.

In this example the CMM 32 comprises jointed arms 34 and a probe 36. CMMs exist which do not include such jointed arms, or include only one jointed arm. For example a CMM may comprise a three actuators, each movable along only one axis. A base actuator may be able to move a tower along an x-axis. A tower actuator may be able to move a beam carried by the tower along a z axis and a beam actuator may be able to move a CMM probe carriage carried on the beam along a y-axis. The CMM probe extends from the probe carriage. In this way a position of the CMM probe can be determined from the x position of the tower, the z position of the beam and the y position of the probe carrier. Any suitable CMM can be used as the reference device.

A CMM controller 38 controls the CMM 32 so that the probe touches the object 4 to create reference data. With the object 5 in each location the probe 36 may touch the object 4 a plurality of times to create the reference data.

The controller 116 of system 101 is able to control the robot arm 120 to move the object 4 to each of the plurality of locations. In each location the controller 116 is able to control the scanner 2 to create scan data and the controller 116 is also able to control the CMM via the CMM controller 38 to create reference data.

The controller 116 and the CMM controller 38 may be separate, or may be integrated into a single controller. The controller 116 may comprise a plurality of other controllers, for example a controller for the robot arm 120 and/or a controller for the scanner 2.

The system 101 operates in a similar way to the system 1, with the object 4 being moved to a plurality of locations, in this example automatically by the robot arm 120, and in each of those locations the scanner 102 scans the object 4 and the reference device 118, in this case the CMM 32, generates reference data relating to the object 4.

By separating the movement of the object 4 from the reference device the system 101 allows a standard object support to be used. In this example the object support is a robot arm 120 the end of which is able to move in each of an x-, y- and z-axis, but the object may be supported by any suitable support. The x-, y- and z-axes are perpendicular to one another.

In other examples the object 4 may be supported on a platform that is movable in the z-axis and which carries a two-axis support which carries the object 4 and is able to move that object in the x- and y-axis thus allowing the object 4 to be moved in all axes. Other object supports allowing an object to be moved to a plurality of locations, either automatically, manually, or otherwise can be used. The object support holds the object in each of the plurality of locations while the scan data and reference data are generated. The stability of the support when holding the object 4 in the plurality of locations may be sufficient so that unacceptable errors are not introduced during the generation of scan data or reference data. The stability might be affected by, for example flutter, vibration or other motions of the object support.

The scan data and reference data can then be processed as described above to create error data.

FIG. 4 is an example of a representation 40 of the positional errors identified in scan data. In each of the plurality of locations 30 the positional error is represented by an arrow. The direction of each arrow 42 indicates the direction the error and the length of each arrow 42 indicates the magnitude of the error. This representation 40 of the error may assist with characterising the errors and then creating a method of correcting those errors.

FIG. 5 shows a flow chart 44 of an example of a method. The method begins with moving the object 46 to a location relative to a scanner and generating scan data and reference data 48 using a scanner and a reference device. The movement of the object may be manual, or may be automatic.

A check 50 is then made to determine whether the object has been moved to all of the locations relative to the scanner and, if not the method returns to the first step 46 and moves the object to a new location and the scan data and reference data is generated 48 again for the new object location.

Once the object has been moved to all of the locations intended the scan data and reference data are automatically processed 52 to create scan position data and reference position data. The scan position data is based upon the scan data and is indicative of a location of the object. The reference position data is based upon the reference data and is indicative of a location of the object.

Error data is then automatically generated 54 from the scan position data and the reference position data. The generation of error data may include aligning the coordinate systems of the reference device and scanner. This aligning may be carried out using a least square estimate.

In some examples, when the scan position data and reference position data are created 52 the scan data may be automatically processed to create scan dimension data indicative of a measured scan dimension of the object at each location and the reference data may be automatically processed to create reference dimension data indicative of a reference dimension of the object at each location. The error data may then include an indication of a dimension error at each of the plurality of locations based on the scan dimension data and the reference dimension data. This allows the creation of more comprehensive error data which may facilitate the characterisation and possibly also the subsequent correcting of errors in the error data.

FIGS. 6a and 6b show options for using the error data created by the method set out above. In FIG. 6a an error profile is created 56 from the error data and the error profile is used to update calibration data of the scanner 58.

In FIG. 6b an error profile is created 56 from the error data and the error profile is used to create a volumetric correction 60.

In operation, the controller 116 may instruct the robot arm 120 to move the object 4 to a plurality of locations within the volume to be tested.

At each of the plurality of locations of the object 4 the CMM 32 is instructed by the CMM controller 38, which is controlled by the controller 116, to measure a set of predetermined features of the object 4. In this example the object 4 is spherical and the CMM is instructed to touch the object in a plurality of positions to create reference data which can be processed to generate reference position data indicative of the position of the centre of the sphere and to generate reference dimension data indicative of, for example the diameter of the sphere.

This reference position data and reference dimension data may be saved into a CSV (comma-separated values) file which can be processed later. At each of the plurality of locations, but at a different time to avoid interference from the CMM probe 36, the scanner 102 is instructed by the controller 116 to scan the object and create scan data. In this example the scan data comprises point cloud information which can processed to create scan position data and scan dimension data, for example the point cloud may be triangulated to form a mesh structure which can be saved in a suitable 3D file format, for example as ‘STU’ or ‘OBJ’. The mesh files can be further processed, for example using a using a least-squares sphere fitting process to determine the diameter and position of the centre of the sphere.

After the object has been moved to each of the plurality of locations and scan data and reference data has been generated for each location and has been processed, the reference position data and reference dimension data can be compared with the scan position data and scan dimension data.

In some examples the co-ordinate systems of the scanner 102 and CMM 32 may differ and they can be aligned to facilitate processing of position data, for example using a least squares estimate the co-ordinate systems can be aligned by finding a rigid three dimensional transformation that minimises the Euclidean geometrical error between the data sets. It will be understood that dimension data can be compared between the scan and reference dimension data without aligning the coordinate systems.

Once the co-ordinate systems have been aligned, the differences between the position data can be determined. In some example the data can be combined with the determined differences between the dimension data to produce error data.

The scan data may also comprise some additional data associated with the object support, for example associated with the robot arm. This data which relates to objects other than the object 4 of interest is referred to as ‘clutter’. This can present a challenge for subsequent processing, for example for the sphere fitting process

To simplify the subsequent processing of the data, the scan data may be decluttered to leave data relating only to the object 4. In some example decluttering may be based on a priori knowledge of where the test artefact is located with respect to the scanning device as this allows just the scan data, for example the mesh, in the expected region of the object 4, plus a tolerance band, to be preserved. This decluttering may speed up the sphere fitting process and may make the processing of the scan data more robust.

In this example, the CMM data provides an indication of the position of the object 4 in each of the plurality of locations. By estimating an appropriate transformation to align the co-ordinate systems of the CMM and the scanner it is possible to estimate the object position with respect to the scanner. In this example some of the scan data is processed before decluttering, for example processing scan data relating to fewer than all the object locations, for example 2, 3 or 4 locations. For this reduced number of locations a RANSAC (RANdom SAmple and Consensus) approach can provide a way of dealing with the clutter in individual scan data from which a suitable estimated transformation to align the co-ordinate systems of the

CMM and the scanner can be determined. In other example the estimated transform may be known in advance, for example from previous test results and/or using human guidance. With this estimate of the transformation the remaining scan data can be decluttered.

Generating error data in this way allows the performance of a scanner to be assessed and for the nature of those errors to be characterised. This could include observing how the error data varies as a scanner is adjusted so that the effects of adjustments, for example to system parameters (e.g. baseline, focus, zoom, etc.), and the details of calibration routines affect the performance of the scanner. This may allow the creation of improved calibration routines and/or improved scanner parameters.

The error data can also be used to determine volumetric correction parameters that can be applied to scan data or scan position data to reduce systematic error. For example, rather than a rigid 3D transformation matrix used to map between the coordinate frames of the scanner and CMM, a relaxed linear (Affine) and/or non-linear (Projective) transform can be applied to the scan data. Such a transform may reduce errors and/or improve geometrical accuracy over the volume mapped by the device. Piecewise linear mappings or radial basis/thin plate spline approaches might be used in addition, or as an alternative, to improve accuracy within a particular portion of the volume mapped.

FIG. 7 shows a schematic representation of an example of a controller 216. In this example the controller 216 comprises a non-transitory computer-readable storage medium 62 comprising instructions 64 executable by a processor. The machine-readable storage medium 62 comprising:

Instructions 66 to generate scan data by scanning an object at a plurality of locations relative to a scanner.

Instructions 68 instructions to automatically process the scan data to create scan position data indicative of a measured scan position of the object at each location.

Instructions 70 to automatically process reference data received from a reference device to create reference position data indicative of a measured reference position of the object at each location. The reference data relating to measurements of the object at the plurality of locations relative to the scanner.

a. Instructions 72 to process the scan position data and reference position data to generate error data indicative of a position error at each of the plurality of locations.

The non-transitory machine-readable storage medium may comprise instructions 74 to use a robot of the scanning system to automatically move the object to each of the plurality of locations.

The non-transitory computer-readable storage medium 62 may further comprise instructions to carry out any of the actions described above, either directly under the control of the controller 216 or through another controller.

1. A system comprising a scanner to scan an object and a controller, the controller to cause:
at each of a plurality of locations, the scanner to scan an object to create scan data and cause a reference device to create reference data relating to the object;
the scan data to be processed to create scan position data indicative of a measured scan position of the object at each location;
the reference data to be processed to create reference position data indicative of a measured reference position of the object at each location; and
the generation of error data indicative of a position error in the scan data at each of the plurality of locations based on the scan position data and the reference position data.

2. The system of claim 1, in which the system includes the reference device and the reference device has measurement accuracy in which errors are 30% of those anticipated from the scanner.

3. The system of claim 1, in which the scanner is a structured light scanner and the reference device is a coordinate measuring machine.

4. The system of claim 1, in which the system includes a robot to move an object relative to the scanner and the controller causes the robot to move the object to a plurality of locations relative to the scanner.

5. The system of claim 1, in which the controller causes calibration data associated with the scanner to be updated to reduce systemic volumetric errors in the scan data.

6. A method comprising:
moving an object to a plurality of locations relative to a scanner;
at each of the plurality of locations using the scanner to scan the object to create scan data and using a reference device to create reference data relating to the object;
automatically processing the scan data to create scan position data indicative of a measured scan position of the object at each location;
automatically processing the reference data to create reference position data indicative of a measured reference position of the object at each location;
automatically generating error data indicative of a position error at each of the plurality of locations based on the scan position data and the reference location data.

7. The method of claim 6, in which the object is moved to the plurality of locations automatically.

8. The method of claim 6, in which generating the error data includes comparing the scan position data and reference position data for each of the plurality of locations and using a least squares estimate to align a coordinate system of the scanner and a coordinate system of the reference device.

9. The method of claim 6, in which the scanner includes calibration data and the calibration data is updated based on the error data to reduce systemic errors in the scan data.

10. The method of claim 6, in which a volumetric correction is generated based on the error data, the volumetric correction including correction parameters that can be applied to scan data to produce corrected scan data in which systemic errors in the scan data are reduced.

11. The method of claim 10, in which the volumetric correction comprises a correction transformation matrix.

12. The method of claim 6, in which at least some of the scan data is de-cluttered to remove data not relating to the object to facilitate processing to create the scan position data.

13. The method of claim 6, in which:
the scan data is automatically processed to create scan dimension data indicative of a measured scan dimension of the object at each location;
the reference data is automatically processed to create reference dimension data indicative of a reference dimension of the object at each location; and
the error data includes an indication of a dimension error at each of the plurality of locations based on the scan dimension data and the reference dimension data.

14. A non-transitory machine-readable storage medium comprising instructions executable by a processor, the machine-readable storage medium comprising:
instructions to generate scan data by scanning an object at a plurality of locations relative to a scanner; and
instructions to automatically process the scan data to create scan position data indicative of a measured scan position of the object at each location;
instructions to automatically process reference data received from a reference device to create reference position data indicative of a measured reference position of the object at each location, the reference data relating to measurements of the object at the plurality of locations relative to the scanner;
instructions to process the scan position data and reference position data to generate error data indicative of a position error at each of the plurality of locations.

15. The non-transitory machine-readable storage medium of claim 14, in which the machine-readable storage medium comprises instructions to use a robot of the scanning system to automatically move the object to each of the plurality of locations.
